(19) United States
(12) Patent Application Publication
(10) Pub. No.: US 2008/0026749 A1
(43) Pub. Date: Jan. 31, 2008

(54) MULTIPLE INDEPENDENT USER ACCESS TO A WIRELESS COMMUNICATION DEVICE

(75) Inventors: Roberto Gautier, Davie, FL (US); Jason T. Young, Palm City, FL (US); Jose F. Rodriguez, Miami, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/461,215

(22) Filed: Jul. 31, 2006

(51) Int. Cl. H04Q 7/20

(52) U.S. Cl. 455/435.1

(57) ABSTRACT

A communication device (100) that includes a first transceiver (110) and at least a second transceiver (130). A first user interface (160) can be communicatively linked to the first transceiver to support a first call session and a second user interface (170) can be communicatively linked to the second transceiver to support a second call session that is simultaneous to the first call session. The first user interface can include a first input audio transducer (214) and a first output audio transducer (318). Similarly, the second user interface can include a second input audio transducer (218) and a second output audio transducer (324). The first user interface can be operable in a first mode in which it is communicatively linked to the first transceiver and a second mode in which it is communicatively linked to the second transceiver.

### BACKGROUND OF THE INVENTION

1. Field of the Invention

The present invention generally relates to wireless communication devices.

2. Background of the Invention

The use of mobile stations has grown to an extent that such devices are now ubiquitous throughout most of the industrialized world. Just as their use has grown, so too has the functionality of the mobile stations. Indeed, mobile stations now can be used not only for voice communications, but also to perform a number of other functions. For example, mobile stations can be used to browse the Internet, send and receive e-mail and instant messages, play games, take photographs and capture video. Moreover, mobile stations also can communicate with other devices, such as mobile station accessories defined within the mobile station's personal area network. Notwithstanding the wide range of functionality already implemented by mobile stations, consumers continue to demand that such devices become increasingly versatile.

### SUMMARY OF THE INVENTION

The present invention relates to a communication device that includes a first transceiver and at least a second transceiver. A first user interface can be communicatively linked to the first transceiver to support a first call session and a second user interface can be communicatively linked to the second transceiver to support a second call session that is simultaneous to the first call session. The first transceiver can be a dispatch transceiver, and the second transceiver can be an interconnect transceiver.

The first user interface can include a first input audio transducer and a first output audio transducer. Similarly, the second user interface can include a second input audio transducer and a second output audio transducer. The first user interface can be operable in a first mode in which it is communicatively linked to the first transceiver and a second mode in which it is communicatively linked to the second transceiver. Likewise, the second user interface can be operable in a first mode in which it is communicatively linked to the first transceiver and a second mode in which it is communicatively linked to the second transceiver.

The communication device further can include a first multiplexer that selectively links the first user interface to the first transceiver or the second transceiver. The first multiplexer further can selectively link the second user interface to the first transceiver or the second transceiver. In another arrangement, a second multiplexer can selectively link the second user interface to the first transceiver or the second transceiver. In one arrangement, the first multiplexer can be an analog audio multiplexer and the second multiplexer can be a digital audio multiplexer. In another arrangement, both multiplexers can be analog audio multiplexers or both multiplexers can be digital audio multiplexers.

The present invention also relates to a method for supporting a plurality of simultaneous call sessions. The method can include communicatively linking a first user interface with a first transceiver to support a first call session, and communicatively linking a second user interface with a second transceiver to support a second call session. Communicatively linking the first user interface with the first transceiver can include multiplexing audio data exchanged between the first user interface and the first transceiver. Similarly, communicatively linking the second user interface with the second transceiver can include multiplexing audio data exchanged between the second user interface and second first transceiver.

### BRIEF DESCRIPTION OF THE DRAWINGS

Preferred embodiments of the present invention will be described below in more detail, with reference to the accompanying drawings, in which:

FIG. 1 depicts a block diagram of a communication device that is useful for understanding the present invention;

FIG. 2 depicts a block diagram of an analog input audio multiplexing system that is useful for understanding the present invention;

FIG. 3 depicts a block diagram of an analog output audio multiplexing system that is useful for understanding the present invention;

FIG. 4 depicts a block diagram of a digital input audio multiplexing system that is useful for understanding the present invention;

FIG. 5 depicts a block diagram of a digital output audio multiplexing system that is useful for understanding the present invention; and

FIG. 6 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a communication device that includes multiple transceivers which may be used to support a plurality of simultaneous call sessions. For instance, a first user may use a first transceiver in the communication device to converse over a first communications network while a second user uses a second transceiver in the communication device to converse over a second communications network. Further, the communication device can include multiple user interfaces, each of which may be selectively linked to any of the transceivers. For example, the first user can converse using input and output audio transducers integrated into the communication device, while the second user converses using a wireless headset.

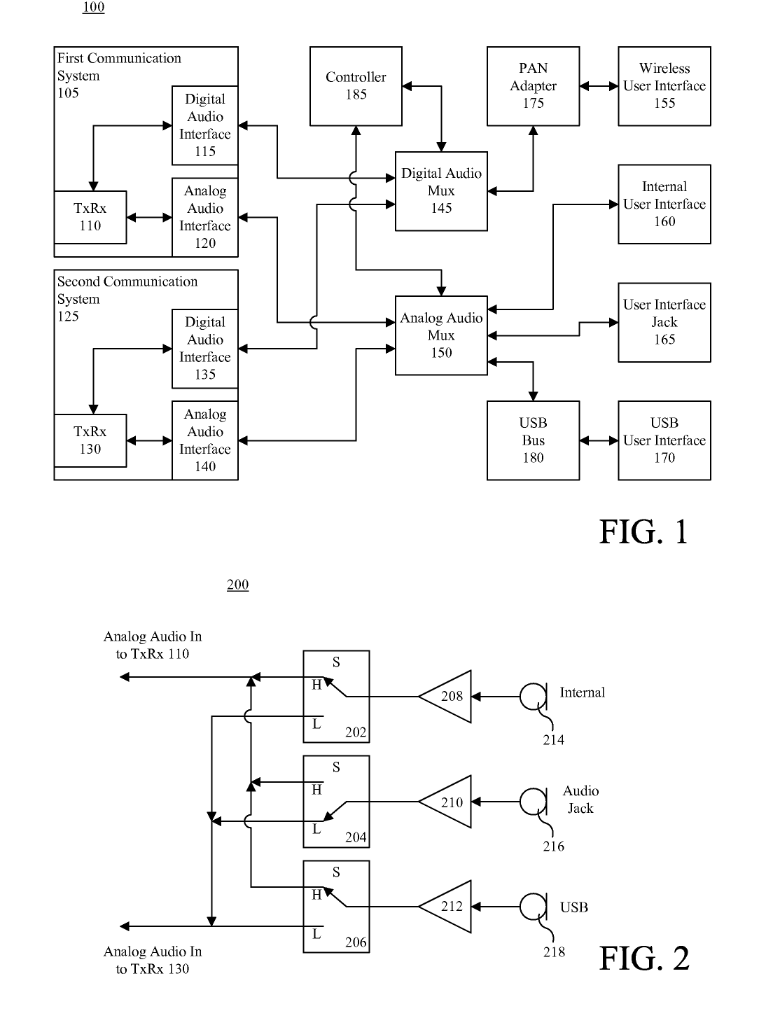

FIG. 1 depicts a block diagram of a communication device 100 that is useful for understanding the present invention. The communication device 100 can be a mobile station, such as a mobile computer, a personal digital assistant (PDA) or a mobile telephone, a game console, or any other electronic apparatus that may be used to wirelessly communicate with one or more communications networks. The communication device 100 can include a first communication system 105 and a second communication system 125. The first and second communication systems 105, 125 can be implemented using one or more integrated circuits and/or using a plurality of discrete components.

Each of the communication systems 105, 125 can include a respective transceiver 110, 130, a respective digital audio interface 115, 135 and a respective analog audio interface 120, 140. In one arrangement, the transceiver 110 can be configured to communicate in accordance with a first communications protocol, and the transceiver 130 can be configured to communicate in accordance with a second communications protocol. Examples of protocols that can be implemented as the first or second protocols include, but are not limited to, dispatch communications, interconnect communications such as any of the IEEE 802 wireless communications protocols, WPA, WPA2, GSM, TDMA, CDMA, WCDMA or TCP/IP, direct wireless communication, or any other suitable form of mobile communications.

The analog audio interfaces 120, 140 can comprise, for example, respective coder-decoders (codecs) for performing analog to digital conversion, digital to analog conversion, and other data coding and decoding. Also by way of example, the digital audio interfaces 115, 135 can include serial audio ports that support pulse code modulated audio signals. Nonetheless, the invention is not limited in this regard and any other suitable digital audio interfaces can be used.

In the first communication system 105, the digital audio interface 115 and the analog audio interface 120 each can be communicatively linked to the transceiver 110, for instance using a suitable communications bus. Similarly, in the second communication system 125, the digital audio interface 135 and the analog audio interface 140 each can be communicatively linked to the transceiver 130.

The communication device 100 also can include a digital audio multiplexer 145 and an analog audio multiplexer 150, which multiplex audio data communicated between the transceivers 110, 130, and a plurality of user interfaces 155, 160, 165, 170. Each of the user interfaces 155-170 can comprise an input audio transducer (e.g. microphone) and output audio transducer (e.g. loudspeaker). Optionally, one or more of the user interfaces also may comprise a display, tactile input devices, such as buttons, keys or a touch screen, and/or haptic response systems.

The digital audio multiplexer 145 can interface with a personal area network communications adapter 175, such as a Bluetooth or ZigBee communications adapter, to support audio communications with the wireless user interface 155. An example of the wireless user interface 155 can be, for instance, a wireless headset.

The analog audio multiplexer 150 can support audio communications between the transceivers 110, 130 and the internal user interface 160, which can be integrated into the communication device 100. The analog audio multiplexer 150 also can support audio communications between the transceivers 110, 130 and the user interface jack 165, which may be used to connect a wired user interfaces, such as a wired headsets, to the communication device 100. Further, the analog audio multiplexer 150 can support audio communications between the transceivers 110, 130 and the universal serial bus (USB) interface 170, for instance, by communicating over a USB bus 180. The USB interface 170 can be, for example, an enhanced mini USB (EMU) interface. In another arrangement, an IEEE-1394 (FireWire) bus and user interface (not shown) also can be communicatively linked to the transceivers 110, 130 via the analog audio multiplexer 150.

The communication device 100 also can include a controller 185 operatively linked to the digital audio multiplexer 145 and the analog audio multiplexer 150. The controller 185 can communicate control signals to the respective multiplexers 145, 150 to select which of the user interfaces 155-170, if any, is to be communicatively linked to the transceiver 110 to support a first call session and which of the user interfaces 155-170, if any, is to be communicatively linked to the transceiver 130 to support a second call session. In one arrangement, the controller 185 can be communicatively linked to the user interfaces 155-170 and such selections can be based on user inputs received via one or more of the user interfaces 155-170. Such user inputs can be tactile inputs, acoustic inputs processed using speech recognition, or any other suitable user inputs.

In another arrangement, the controller can automatically select which of the user interfaces 155-170 to communicatively link to the transceivers 110, 130. For example, the controller 185 can monitor the respective user interfaces 155-170 to identify which of the user interfaces 155-170 may be detecting acoustic signals from a user. In a circumstance in which only one of the user interfaces is active to support a call session, the controller 185 can monitor the transceivers 110, 130 to select the transceiver which has the best communication link, and signal the appropriate multiplexer 145, 150 to automatically establish an audio communications link between the active user interface and the selected transceiver. If a second user interface becomes active, the controller can signal the appropriate multiplexer 145, 150 to automatically establish an audio communications link between the second user interface and the unused transceiver to support a second call session.

FIG. 2 depicts a block diagram of an analog input audio multiplexing system (AIM) 200 that may be implemented in the analog audio multiplexer 150. The AIM 200 can include a plurality of switches 202, 204, 206. The AIM 200 also can include a plurality of amplifiers 208, 210, 212 coupled between the switches 202, 204, 206 and input audio transducers 214, 216, 218. The input audio transducer 214 can be a component of the internal user interface; the input audio transducer 216 can be connected to the user interface jack; and the input audio transducer 218 can be a component of the USB user interface.

To selectively link the input audio transducers 214, 216, 218 to the transceivers 110, 130 to support call sessions, the switches 202, 204, 206 can be selectively toggled between positions “H” and “L” and the amplifiers 208, 210, 212 can be selectively activated and/or deactivated. Thus, each of the user interfaces can operate in a first mode in which they are communicatively linked to the transceiver 110, and a second mode in which they are communicatively linked to the transceiver 130. Toggling of the switches 202, 204, 206 and activation/deactivation of the amplifiers 208, 210, 212 can be performed in response to the control signals provided by the controller.

To direct audio signals from any one of the input audio transducers 214, 216, 218 to the transceiver 110, the switches 202, 204, 206, to which the input audio transducers 214, 216, 218 are coupled, can be toggled to the position “H.” To direct audio signals from any one of the input audio transducers 214, 216, 218 to the transceiver 130, the switches 202, 204, 206, to which the input audio transducers 214, 216, 218 are coupled, can be toggled to the position “L.” Further, the amplifiers 208, 210, 212 coupled to any input audio transducers 214, 216, 218 that are being used, can be activated, while the amplifiers 208, 210, 212 coupled to any input audio transducers 214, 216, 218 that are not being used can be deactivated.

For example, assume that the internal input audio transducer 214 is to be communicatively linked to the transceiver 110, the input audio transducer 216 connected to the audio jack is to be communicatively linked to the transceiver 130, and the USB input audio transducer is unused. In this configuration, the amplifiers 208 and 210 can be activated, and the amplifier 212 can be deactivated. Further, the switch 202 can be toggled to position “H” and the switch 204 can be toggled to position “L.” Since the amplifier 212 is deactivated, the amplifier 212 will not apply any signals to the switch 206, and the position of the switch 206 is therefore irrelevant until the amplifier 212 is again activated.

If at any time it is desired to communicatively link the internal input audio transducer 214 to the transceiver 130, the switch 202 can be toggled to the “L” position. Similarly, the switch 206 can be toggled to the “L” position to communicatively link the USB input audio transducer 218 to the transceiver 130. Of course, the amplifiers 210, 212 can be activated if not already. Accordingly, a plurality of user interfaces can be simultaneously communicatively linked with the transceiver 130. Likewise, two or more of the switches 204-206 can be toggled to the “H” position to communicatively link two or more of the user interface input audio transducers 214-218 with the transceiver 110.

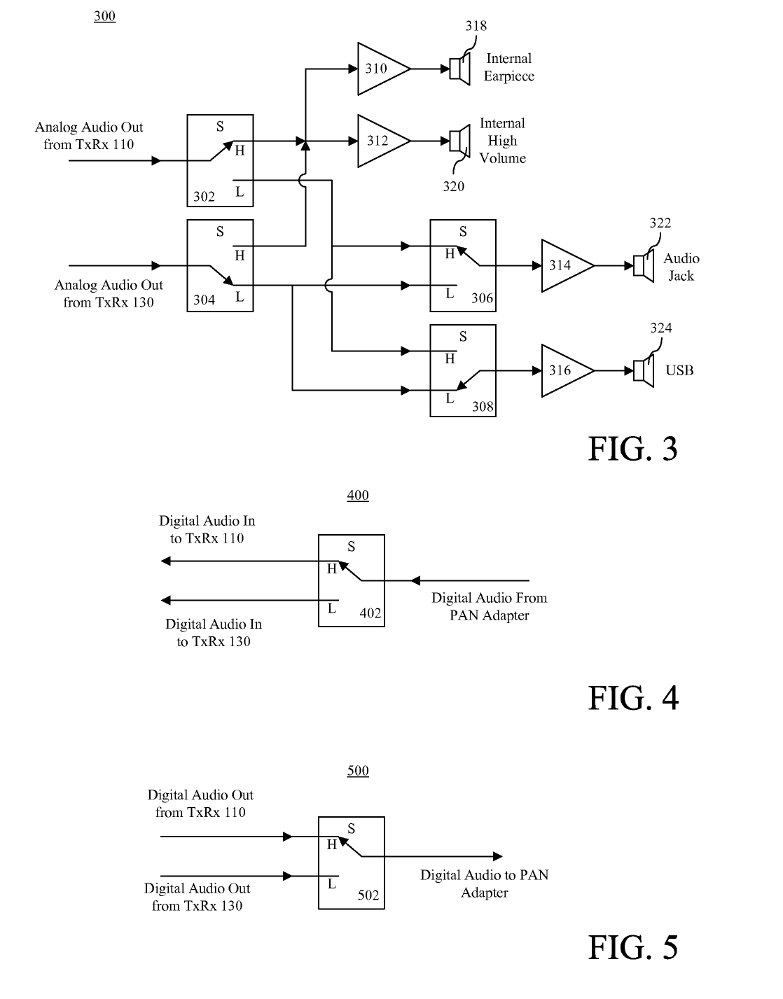

FIG. 3 depicts a block diagram of an analog output audio multiplexing system (AOM) 300 that may be implemented in the analog audio multiplexer 150. The AOM 300 can include a plurality of switches 302, 304, 306, 308 that can be selectively toggled and a plurality of amplifiers 310, 312, 314, 316 that can be selectively activated/deactivated in order to communicatively link one or more output audio transducers 318, 320, 322, 324 with the transceiver 110 and/or the transceiver 130 to support a plurality of simultaneous call sessions.

The switch 302 can be toggled to the “H” position to communicatively link the internal earpiece output audio transducer 318 and/or the internal high volume output audio transducer 320 to the transceiver 110. Similarly, the switch 304 can be toggled to the “H” position to communicatively link the internal earpiece output audio transducer 318 and/or the internal high volume output audio transducer 320 to the transceiver 130. The amplifiers 310, 312 can be selectively activated to activate the respective output audio transducers 318, 320, or selectively deactivated to deactivate the respective output audio transducers 318, 320.

The switches 302, 304 can be toggled to the “L” position to direct audio output from the respective transceivers 110, 130 to the switches 306, 308, which can be selectively toggled to complete the communication links between one or more of the output audio transducers 322, 324 and the transceivers 110, 130. For example, the switch 302 can be toggled to the “L” position, the switch 306 can be toggled to the “H” position, and the amplifier 314 can be activated to communicatively link the output audio transducer 322 to the transceiver 110. The switch 304 and switch 308 each can be toggled to the “L” position and the amplifier 316 can be activated to communicatively link the output audio transducer 324 to the transceiver 130. Still, the switches 302-308 can be selectively toggled and the amplifiers 310-316 can be selectively activated/deactivated to implement any of a myriad of communication link configurations between the transceivers 110, 130 and output audio transducers 318-324, and the invention is not limited in this regard. Moreover, as noted for the input audio transducers, one or more of the output audio transducers 318-324 can be communicatively linked to the transceiver 110 and/or one or more of the output audio transducers 318-324 can be communicatively linked to the transceiver 130.

An output audio transducer 318-324 can be communicatively linked to the transceiver to which a corresponding input audio transducer in the same user interface is communicatively linked. For example, the output audio transducer 318 can be communicatively linked to the same transceiver 110 to which the internal input audio transducer is linked. Nonetheless, there may be circumstances in which it is desired to use a first user interface for audio signals sent to the transceiver 110 and a second user interface for outbound audio signals received from the transceiver 110. Accordingly, the communication links established by the AOM 300 may or may not match the communication links established by the AIM 200 of FIG. 2.

FIG. 4 depicts a block diagram of a digital input audio multiplexing system (DIM) 400 that may be implemented in the digital audio multiplexer 145. The DIM 400 can comprise a switch 402. When toggled to the “H” position, the switch 402 can communicatively link the input audio transducer in the wireless user interface to the transceiver 110. When toggled to the “L” position, the switch 402 can communicatively link the input audio transducer in the wireless user interface to the transceiver 130.

FIG. 5 depicts a block diagram of a digital output audio multiplexing system (DOM) 500 that may be implemented in the digital audio multiplexer 145. The DOM 500 can comprise a switch 502. When toggled to the “H” position, the switch 502 can communicatively link the output audio transducer in the wireless user interface to the transceiver 110. When toggled to the “L” position, the switch 502 can communicatively link the output audio transducer in the wireless user interface to the transceiver 130. As with the analog multiplexing systems, the communication links established by the DOM 500 may or may not match the communication links established by the DIM 400 of FIG. 4.

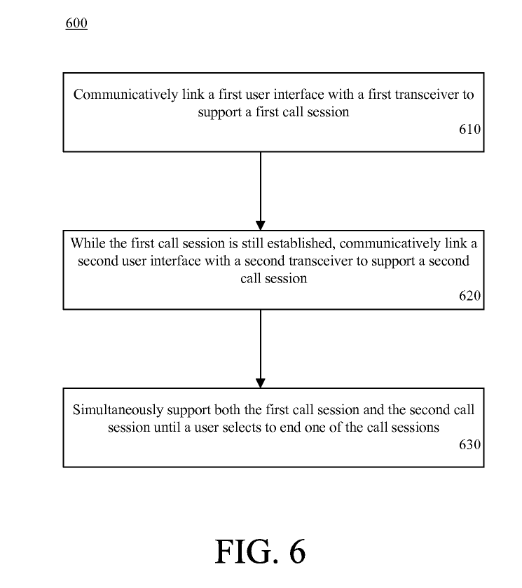

FIG. 6 is a flowchart presenting a method 600 that is useful for understanding the present invention. Beginning at step 610, a first user interface can be communicatively linked with a first transceiver to support a first call session. Proceeding to step 620, while the first call session is still established, a second user interface can be communicatively linked to a second transceiver to support a second call session. Continuing to step 630, both the first and second call sessions can be simultaneously supported until a user selects to end one of the call sessions.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A communication device, comprising:
a first transceiver;
a second transceiver;
a first user interface that is communicatively linked to the first transceiver to support a first call session; and
a second user interface that is communicatively linked to the second transceiver to support a second call session that is simultaneous to the first call session.

2. The communication device of claim 1, wherein the first user interface is operable in a first mode in which it is communicatively linked to the first transceiver and a second mode in which it is communicatively linked to the second transceiver.

3. The communication device of claim 2, wherein the second user interface is operable in a first mode in which it is communicatively linked to the first transceiver and a second mode in which it is communicatively linked to the second transceiver.

4. The communication device of claim 1, further comprising a first multiplexer that selectively links the first user interface to the first transceiver or the second transceiver.

5. The communication device of claim 4, wherein the first multiplexer further selectively links the second user interface to the first transceiver or the second transceiver.

6. The communication device of claim 4, further comprising a second multiplexer that selectively links the second user interface to the first transceiver or the second transceiver.

7. The communication device of claim 6, wherein the first multiplexer is an analog audio multiplexer and the second multiplexer is a digital audio multiplexer.

8. The communication device of claim 1, wherein:
the first user interface comprises a first input audio transducer and a first output audio transducer; and
the second user interface comprises a second input audio transducer and a second output audio transducer.

9. The communication device of claim 1, wherein the first transceiver is a dispatch transceiver and the second transceiver is an interconnect transceiver.

10. A communication device, comprising:
a first transceiver;
a second transceiver;
a first user interface that is communicatively linked to the first transceiver to support a first call session;
a second user interface that is communicatively linked to the second transceiver to support a second call session that is simultaneous to the first call session; and
a first multiplexer that selectively links the first user interface to the first transceiver or the second transceiver.

11. The communication device of claim 10, wherein the first multiplexer further selectively links the second user interface to the first transceiver or the second transceiver.

12. The communication device of claim 10, further comprising a second multiplexer that selectively links the second user interface to the first transceiver or the second transceiver.

13. The communication device of claim 12, wherein the first multiplexer is an analog audio multiplexer and the second multiplexer is a digital audio multiplexer.

14. The communication device of claim 10, wherein the first user interface is operable in a first mode in which it is communicatively linked to the first transceiver and a second mode in which it is communicatively linked to the second transceiver.

15. The communication device of claim 14, wherein the second user interface is operable in a first mode in which it is communicatively linked to the first transceiver and a second mode in which it is communicatively linked to the second transceiver.

16. The communication device of claim 10, wherein:
the first user interface comprises a first input audio transducer and a first output audio transducer; and
the second user interface comprises a second input audio transducer and a second output audio transducer.

17. The communication device of claim 10, wherein the first transceiver is a dispatch transceiver and the second transceiver is an interconnect transceiver.

18. A method for supporting a plurality of simultaneous call sessions, comprising:
communicatively linking a first user interface with a first transceiver to support a first call session; and
communicatively linking a second user interface with a second transceiver to support a second call session.

19. The method of claim 18, wherein communicatively linking the first user interface with the first transceiver comprises multiplexing audio data exchanged between the first user interface and the first transceiver.

20. The method of claim 19, wherein communicatively linking the second user interface with the second transceiver comprises multiplexing audio data exchanged between the second user interface and second first transceiver.
